(19) United States
(12) Patent Application Publication
(10) Pub. No.: US 2010/0157145 A1
(43) Pub. Date: Jun. 24, 2010

(54) ADAPTIVE PANORAMIC INTERPOLATOR

(75) Inventor: Ilan Dimnik, Rishon Le Zion (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/342,392

(22) Filed: Dec. 23, 2008

(51) Int. Cl. H04N 7/01

(52) U.S. Cl. 348/445; 348/E07.003

(57) ABSTRACT

The present invention relates to a method for panoramically interpolating a video from a first aspect ratio to a second aspect ratio comprising the steps of: (a) receiving at least one frame; (b) tracking said frame horizontally or vertically pixel line by pixel line; (c) computing the average luminance value of each of said pixel lines; (d) comparing each said average luminance value to a set threshold for finding the superfluous lines; (e) trimming said frame by deleting said superfluous lines; (f) calculating the required curve for the panoramic scaling of said trimmed frame; and (g) interpolating said trimmed frame into a panoramic display based on said calculations.

### FIELD OF THE INVENTION

The present invention relates to the field of adaptive display interpolators. More particularly, the invention relates to a method for panoramically interpolating a video, whose initial aspect ratio is different from the aspect ratio of the display screen, based on the contents of the video.

### BACKGROUND OF THE INVENTION

Today, the broadcasted TV videos are typically mixed between two different standard aspect ratios of 16:9 and 4:3. This mix-up is due to the different standards of TV broadcasting which have evolved over the years. In consequence, today's TV sets also differ in their native aspect ratio in accordance with these standards. Therefore, a certain TV with a specific native aspect ratio is sometimes required to interpolate the incoming broadcasted aspect ratio to fit its native aspect ratio. The changing of aspect ratio may be done in a number of ways depending on the resolution capabilities and native aspect ratio of the TV set, and depending on the contents and parameters of the TV broadcasts.

Changing an image of a video from a 4:3 aspect ratio to a 16:9 aspect ratio may be done using one of the following techniques: (a) by adjusting the horizontal length (width) of the image to the horizontal length of the screen, so that upper and lower parts of each image of the incoming video are left out during display, otherwise known as “center cut”. (b) By shrinking the display of the incoming video so as to adjust the vertical length (height) of the image to the vertical length of the screen, thereby presenting two thick black stripes on the sides of the screen, otherwise known as “letter box”. (c) By adjusting the vertical length of the image to the vertical length of the screen and linearly up scaling the horizontal length of the image to fit the screen, whereby the original aspect ratio within the image is no longer maintained. (d) By adjusting the vertical length of the image to the vertical length of the screen and panoramically (symmetrically, non-linearly) up scaling the horizontal length of the image to fit the screen.

Changing an image of a video from a 16:9 aspect ratio to a 4:3 aspect ratio may be done using the following techniques: (a) by adjusting the vertical length (height) of the image to the vertical length of the screen, so that certain parts of each image's sides of the incoming video are left out, otherwise known as “center cut”. (b) By shrinking the display of the incoming video so as to adjust the horizontal length (width) of the image to the horizontal length of the screen, thereby presenting two thick black stripes on top and bottom of the screen, otherwise known as “letter box”. (c) By adjusting the vertical length of the image to the vertical length of the screen and linearly down scaling the horizontal length of the image to fit the screen, whereby the original aspect ratio within the image is no longer maintained. (d) By adjusting the vertical length of the image to the vertical length of the screen and panoramically (symmetrically, non-linearly) down scaling the horizontal length of the image to fit the screen.

All the above mentioned techniques have their drawbacks; however, the panoramic adjustment exploits all the screen area and provides a good un-distorted view of the center of the image, where most of the important details are displayed.

In some of the cases, the video contents themselves are broadcasted in a different aspect ratio than their initial aspect ratio. For example, a movie which was initially filmed using an aspect ratio of 16:9 is sometimes broadcasted using a standardized 4:3 aspect ratio. In this example, the black stripes, of the letter box technique, are added to the video data prior to broadcasting in order to provide a broadcast of the standardized 4:3 aspect ratio. However, when the user's TV receives this broadcast it treats the incoming video as a regular standardized 4:3 video without taking into account that some of the video data is superfluous. In some of the cases, the user's TV will re-interpolate this video to fit the native aspect ratio of the TV, which may be different. In this case, the re-interpolation may cause an even greater distortion, loss of data, or unfilled screen area. Furthermore, the same movie may have different parts which are interpolated differently using the interpolation techniques described above. In this case using the same re-interpolation technique may cause visible distortions during the display of the movie.

US 2007/0098302 discloses an image converter circuit which is capable of converting images to a panoramic display. The disclosed converter can convert the horizontal/vertical number of pixels of an image into the number of pixels of a display device in a panoramic view. However, the disclosed converter does not deal with the contents of the image, its superfluous image data, and the size and color of the superfluous data.

It is an object of the present invention to provide a method for interpolating an image having one aspect ratio into a different aspect ratio.

It is another object of the present invention to provide a method for interpolating a video into a different aspect ratio while discarding the superfluous data in the video.

It is still another object of the present invention to provide a method for interpolating a broadcasted video having an initial aspect ratio into a panoramic display having a different aspect ratio.

It is still another object of the present invention to provide a method for interpolating a broadcasted video having an initial aspect ratio and an initial set resolution into a panoramic display having a different aspect ratio and a different set resolution

Other objects and advantages of the invention will become apparent as the description proceeds.

### SUMMARY OF THE INVENTION

The present invention relates to a method for panoramically interpolating a video from a first aspect ratio to a second aspect ratio comprising the steps of: (a) receiving at least one frame; (b) tracking said frame horizontally or vertically pixel line by pixel line; (c) computing the average luminance value of each of said pixel lines; (d) comparing each said average luminance value to a set threshold for finding the superfluous lines; (e) trimming said frame by deleting said superfluous lines; (f) calculating the required curve for the panoramic scaling of said trimmed frame; and (g) interpolating said trimmed frame into a panoramic display based on said calculations.

The present invention also relates to a method for panoramically interpolating a video from a first aspect ratio to a second aspect ratio comprising the steps of: (a) receiving more than one frame; (b) tracking each frame horizontally or vertically pixel line by pixel line; (c) computing the average luminance value of each of said pixel lines of each frame; (d) comparing each said average luminance value to a set threshold for finding the numbers of superfluous lines; (e) filtering said numbers of said superfluous lines with at least one IIR filter, for producing at least one filtered number of superfluous lines; (f) trimming at least one of said frames by deleting said filtered number of said superfluous lines; (g) calculating the required curve for the panoramic scaling of said trimmed frame; and (h) interpolating said trimmed frame into a panoramic display based on said calculations.

Preferably, the method further comprises the step of detecting if the frame belongs to new scene, and if so calibrating the filter accordingly.

In one embodiment, the received frame belongs to the YC_{b}Cᵣ color space.

In another embodiment, the received frame belongs to the RGB color space.

### BRIEF DESCRIPTION OF THE DRAWINGS

In the drawings:

FIG. 1 is a block diagram of the method of the invention, according to one of the embodiments.

FIG. 2a is an example of a frame that had an initial aspect ratio of 16:9 and was interpolated into a standardized 4:3 aspect ratio.

FIG. 2b is an example of the frame after trimming the superfluous dark ribbons.

FIG. 2c is an example of the frame after scaling and panoramic interpolation.

FIG. 3 is a flow chart depicting the method for interpolating a movie from its initial aspect ratio into different aspect ratio, according to an embodiment of the invention.

### DETAILED DESCRIPTION OF PREFERRED EMBODIMENTS

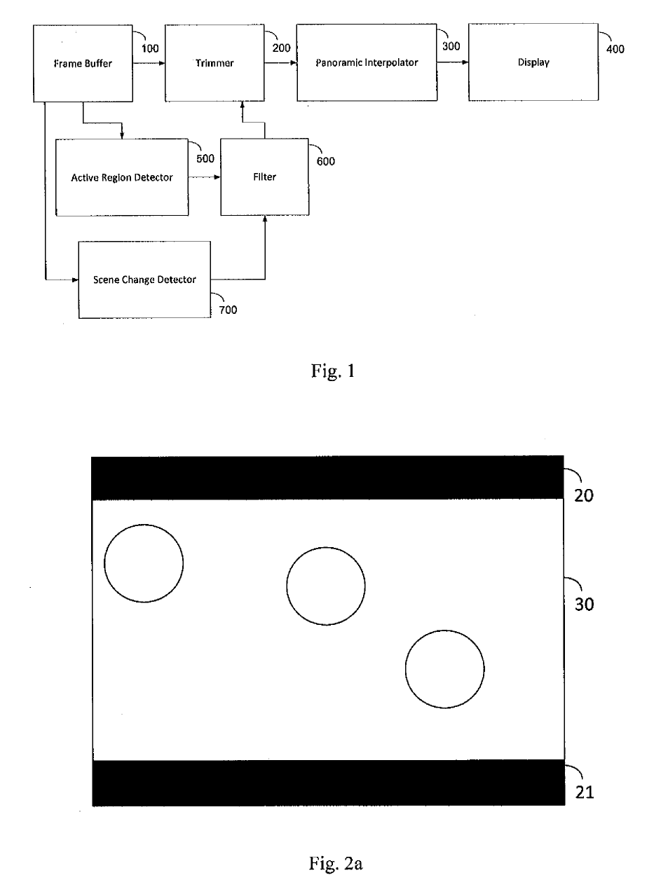

FIG. 1 is a block diagram of the system of the invention, according to one of the embodiments. At first, the Frame Buffer 100 receives a first frame in a readable format where its pixel values can be read, processed, and displayed easily. Typically, in digital broadcasting this stage is reached after decoding the broadcasted encoded bitstream and after the frame is set for display. Although frames of any color space may be used, for the sake of brevity the following description deals with the YC_{b}Cᵣ color space. After a frame is received by frame buffer 100, it is sent to Active Region Detector (ARD) 500, where the frame is searched horizontally and vertically pixel line by pixel line for finding any dark pixel lines. By pixel line it is meant to include a number of pixels configured to be displayed as a full straight line of a frame. The dark pixel lines may belong to the dark stripes of the letter box technique, inserted in order to adjust the frame to one of the standards. Once the numbers of these dark lines are found they are sent to filter 600. The filter 600 uses an Infinite Impulse Response (IIR) filter to track and filter the ARD 500 results for frames of a single scene. Simultaneously, the frame is also sent to Scene Change Detector 700 which checks if this frame continues to be a part of the processed scene or starts a new scene for processing. The Scene Change Detector 700 compares the received frame to the previously received frame, and if there are differences between many corresponding pixels (above a certain threshold) than a signal is sent to filter 600 that this frame starts a new scene. The first frame of the movie is also handled by Scene Change Detector 700 as a frame that belongs to a new scene. The filter 600 sends the found numbers of dark lines, to trimmer 200, if the frame belongs to a new scene, otherwise the filtered numbers of dark lines is sent to trimmer 200. Once trimmer 200 receives the number from filter 600, and the frame from frame buffer 100, it trims the frame accordingly, and the superfluous lines are discarded. The trimmed frame is then sent to the panoramic interpolator 300 which first resizes the frame in order to fit the vertical length of the frame to the vertical length of the display 400. The panoramic interpolator 300 then scales the horizontal lines in a panoramic curve and sends the panoramic frame to display 400 for display. For each frame, filter 600 uses the IIR filter to track and filter the ARD 500 results. The filtered values are sent to trimmer 200. Thus consecutive frames of a scene are trimmed according to the filter 600 filtered numbers which helps to eliminate drastic changes between consecutive frames.

Typically only two IIR filters are needed for a single scene; either in one case: one for the top and one for the bottom, or in another case: one for right and one for left.

For the sake of brevity an example of an IIR filter is set forth:

Y—is the number of dark lines.

a—is a constant (typically less than 1) set by the user which defines the tracking speed and accuracy.

Yₙ=a*Yₙ₋₁+(1−a)Y_{now}

Thus each new number of dark lines (Y_{new}) is fed to the filter and processed with the previous number of dark lines (Yₙ₋₁). The new filtered number (Yₙ) is sent to trimmer 200 for trimming the frame accordingly.

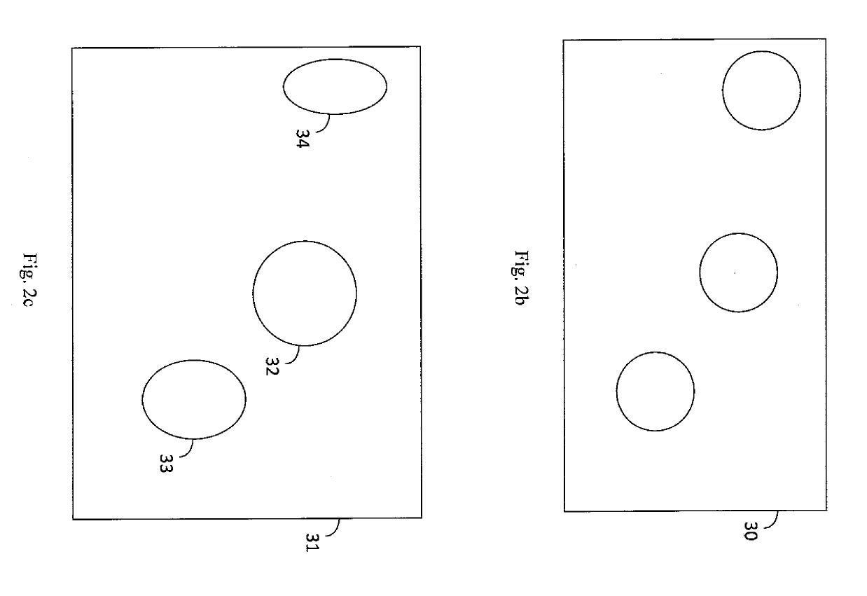

For the sake of brevity a non-limiting example is set forth for illustrating the method of the invention, according to one embodiment. In FIG. 2a an example of a 4:3 decoded frame is shown. The 4:3 decoded frame consists of: the initial frame, showing 3 circles, which has 16:9 aspect ratio and two black stripes 20-21 on the upper and lower part of the frame which have been added in order to comply with the 4:3 aspect ratio standard. As described in relations to FIG. 1 the frame is processed and the upper and lower horizontal lines are found and trimmed. FIG. 2b shows the trimmed frame, which has a 16:9 aspect ratio, without the superfluous dark ribbons. Nevertheless, since the native aspect ratio of the screen chosen to display this image is 4:3, the frame needs to be adjusted further. At this stage the trimmed frame is interpolated panoramically, as shown in FIG. 2c, meaning that the vertical length of the image is adjusted to the vertical length of the screen and the horizontal length of the frame is down scaled symmetrically and relatively to the distance from the vertical center of the frame. In other words, the parts further from the vertical center are skewed more.

For the sake of enablement an example of the scaling of a panoramic curve is calculated forth, according to one embodiment:

In this example a single frame is requested for panoramic interpolation in order to fit a screen having a different aspect ratio.

F_{w}—the width of the frame (in pixels).

Fₕ—the height of the frame (in pixels).

S_{w}—the width of the screen (in pixels).

Sₕ—the height of the screen (in pixels).

Sₕ/Fₕ=Rₕ

S_{w}/F_{w}=R_{w}

Rnorm=Rw/Rh

In this example Rnorm is bigger than one (for example panoramic scaling of 720×480 to 1280×720).

The circumference C of an ellipse is

$$C = 2 π a {\sum }_{n = 0}^{∞} \{ - {[ {\prod }_{m = 1}^{n} ( \frac{2 m - 1}{2 m} ) ]}^{2} \frac{{ɛ}^{2 n}}{2 n - 1} \} ; \qquad equation 1$$

Nevertheless in this case this approximation may be used:

$$C \approx π ( a + b ) ( 1 + \frac{3 {( \frac{a - b}{a + b} )}^{2}}{10 + \sqrt{4 - 3 {( \frac{a - b}{a + b} )}^{2}}} ) ; \qquad equation 2$$

At this point we can assume that C=Rₙₒᵣₘ*2 as the panoramic view is only a half of the total circumference of the ellipse. For the sake of brevity the long axis of the ellipse is 1, meaning that a=½. Thus b can be extracted from equation 2. After extracting b, a and b may be inserted in the ellipse equation:

$$\frac{{x}^{2}}{{a}^{2}} + \frac{{y}^{2}}{{b}^{2}} = 1 \qquad equation 3$$

which equals to:

$$y = b \sqrt{1 - \frac{{x}^{2}}{{a}^{2}}} \qquad equation 4$$

and y may be derived dy/dx.

The derivative dy/dx is then fed into the equation:

$$r ( x ) = {R}_{h} \frac{1}{cos ( {tan}^{- 1} \frac{d y}{d x} )} \qquad equation 5$$

Which allows the calculating of the scaling ratio for pixel at position x in the source frame.

In one of the embodiments, this ratio can be also approximated by quasi linear function.

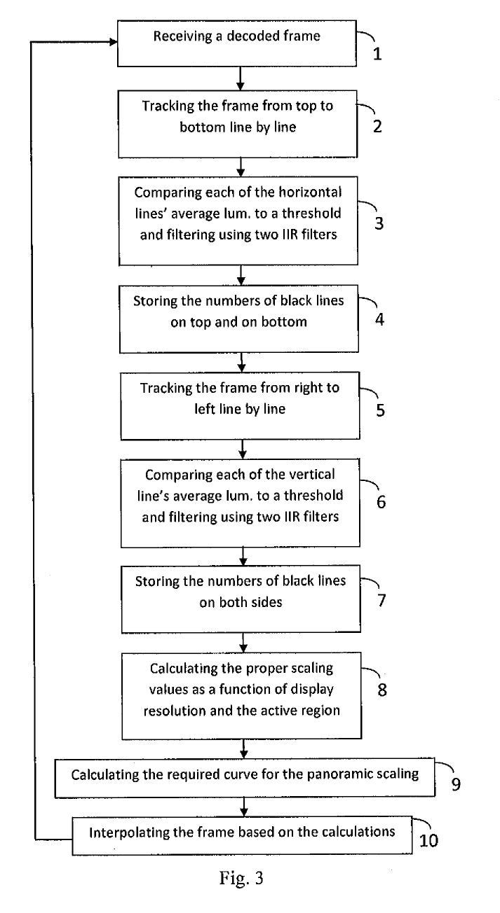

FIG. 3 is a flow chart depicting the method for interpolating a movie from its initial aspect ratio into a different aspect ratio, according to an embodiment of the invention. In step 1, a frame ready for display is received. In step 2, the frame is processed from top to bottom, horizontal pixel line by horizontal pixel line. Each horizontal line is processed to determine the average pixel value of the luminance of the line. For example, in a YC_{b}Cᵣ color space only the Y (luminance) parameter of the pixels is needed for finding the average luminance of the line. Thus the average luminance of a line can be the average Y parameter of all the pixels of the line. In step 3, each average luminance value is compared to a predetermined threshold and filtered using an IIR filter. Since dark lines will typically have an average luminance value under a certain threshold, the comparison will verify which of the frame's horizontal lines are dark. For example, in a YC_{b}Cᵣ color space the Y value of a black pixel can be approximately 16, therefore, if the threshold is set to 21 each line having an average Y value less than 21 is categorized as a dark line. The IIR filter is used to track and normalize the number of dark lines in order to soften a sudden change in the number of dark lines. At this point two IIR filters are used, one for filtering the number of dark lines from the top and one for filtering the number of dark lines from the bottom. In step 4 the filtered value of the number of dark lines from top and the filtered value of number of dark lines from bottom, are stored. In step 5 the frame is processed from left to right vertical pixel line by vertical pixel line, similarly to step 2. Each vertical line is processed to determine the average luminance value of the line. In step 6, each of the vertical average luminance value is compared to a predetermined threshold and filtered using an IIR filter, similarly to step 3. In step 7, both filtered values of the dark lines from both sides are stored. In step 8 the proper scaling factors are calculated as a function of the display resolution and the active region based on the 4 filtered values of dark lines derived in steps 2-7. In this step the frame is trimmed based on these calculations. In step 9 the required curve for the panoramic scaling of the trimmed frame is calculated. In step 10 the trimmed frame is interpolated based on the calculations from step 9. The steps 1-10 are repeated again for each new frame. Nevertheless, although the first frame is trimmed based on the raw number of dark lines, the next pictures will be trimmed based on the filtered number of dark lines, effectively softening sudden changes in the number of dark lines.

In another embodiment the invention may be used for a frame having an any other color space, for example ROB color space. In this embodiment all the pixels' parameters are averaged and compared with a set threshold. For example, a threshold of 5 may be selected where the average of all the RGB parameters of the average pixel of a line must be below in order to effectively define that line as a dark line,

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for panoramically interpolating a video from a first aspect ratio to a second aspect ratio comprising the steps of:
a. receiving at least one frame;
b. tracking said frame horizontally or vertically pixel line by pixel line;
c. computing the average luminance value of each of said pixel lines;
d. comparing each said average luminance value to a set threshold for finding the superfluous lines;
e. trimming said frame by deleting said superfluous lines;
f. calculating the required curve for the panoramic scaling of said trimmed frame; and
g. interpolating said trimmed frame into a panoramic display based on said calculations.

2. A method for panoramically interpolating a video from a first aspect ratio to a second aspect ratio comprising the steps of:
a. receiving more than one frame;
b. tracking each frame horizontally or vertically pixel line by pixel line;
c. computing the average luminance value of each of said pixel lines of each frame;
d. comparing each said average luminance value to a set threshold for finding the numbers of superfluous lines;
e. filtering said numbers of said superfluous lines with at least one IIR filter, for producing at least one filtered number of superfluous lines;
f. trimming at least one of said frames by deleting said filtered number of said superfluous lines;
g. calculating the required curve for the panoramic scaling of said trimmed frame; and
h. interpolating said trimmed frame into a panoramic display based on said calculations.

3. A method according to claim 2, further comprising the step of:
a. detecting if the frame belongs to new scene, and if so calibrating the filter accordingly.

4. A method according to claim 2, where the video comprises scenes having different numbers of superfluous lines.

5. A method according to claim 1, where the received frame belongs to the YC_{b}Cᵣ color space

6. A method according to claim 1, where the received frame belongs to the RGB color space.
